(19) United States
(12) Patent Application Publication
(10) Pub. No.: US 2017/0118188 A1
(43) Pub. Date: Apr. 27, 2017

(54) METHOD AND SYSTEM FOR AUTHENTICATING USER IN WIRELESS LOCAL AREA NETWORK AND TERMINAL DEVICE

(71) Applicant: LEAUTO INTELLIGENT TECHNOLOGY (BEIJING) CO. LTD, Chaoyang District Beijing (CN)

(72) Inventor: Jiejing SHAN, Chaoyang District Beijing (CN)

(21) Appl. No.: 14/978,704

(22) Filed: Dec. 22, 2015

(30) Foreign Application Priority Data
Oct. 21, 2015 (CN) 2015106948816

(51) Int. Cl. H04L 29/06; H04W 84/12

(52) U.S. Cl. CPC H04L 63/08; H04W 84/12; H04L 63/10

(57) ABSTRACT

The present disclosure provides a method and system for authenticating a user of a wireless local area network, and a terminal device. The method includes: obtaining an authentication instruction of permitting a terminal device of the user to access the network; according to the authentication instruction, coding pre-stored authentication information by a pre-configured speech coding algorithm to obtain an audio signal; playing the audio signal and sending the authentication information to a wireless access device, so that after the terminal device of the user detects the audio signal, the terminal device of the user decodes the audio signal to obtain the authentication information and then returns the authentication information to the wireless access device, and the wireless access device determines whether to permit the terminal device of the user to access the network according to the authentication information.

### CROSS-REFERENCE TO RELATED APPLICATIONS

This application is based upon and claims priority to Chinese Patent Application 201510694881.6, titled “Method and System for Authenticating User in Wireless Local Area Network and Terminal Device”, filed on Oct. 21, 2015, the entire contents of which are incorporated herein by reference.

### FIELD OF TECHNOLOGY

The present disclosure generally relates to the technical field of wireless local area network, and more particularly, to a method and system for authenticating a user in a wireless local area network, a terminal device of an administrator, and a terminal device of a user.

### BACKGROUND

With proliferation of smart devices, people become more and more reliant on wireless networks, such as Wireless Fidelity (WiFi) network. However, if a new user wants to join a new WIFI network, the user needs obtain the password of the WiFi network, open WiFi settings, input the WiFi password, and then the user can use the network. A procedure in which an administrator tells a new user a WiFi password is a procedure for authenticating the new user.

There are generally two approaches for joining a WiFi network: one approach is to inquire an administrator about a WiFi password and then manually input the password; another approach is to use WiFi Protected Setup (WiFi WPS) technology to join a WiFi network. As for the first approach, it is inconvenient to inquire an administrator about a WiFi password and then input the password manually. As for the second approach, even though many existing routers support the WiFi WPS technology, such technology is not widely applied. In addition, the administrator needs to press a WPS key on the routers and this also brings inconvenience.

### SUMMARY

The present disclosure provides a method and system for authenticating a user of a wireless local area network, a terminal device of an administrator and a terminal device of a user to improve convenience in authenticating a terminal device of a user.

The present disclosure provides a method for authenticating a user of a wireless local area network. The method is performed at a terminal device side of an administrator and includes:

obtaining an authentication instruction of permitting a terminal device of the user to access the network;

according to the authentication instruction, coding pre-stored authentication information by a pre-configured speech coding algorithm to obtain an audio signal;

playing the audio signal and sending the authentication information to a wireless access device, so that after the terminal device of the user detects the audio signal, the terminal device of the user decodes the audio signal to obtain the authentication information and then sends the authentication information to the wireless access device, and the wireless access device determines whether to permit the terminal device of the user to access the network according to the authentication information.

The present disclosure further provides a method for authenticating a user of a wireless local area network. The method is performed at a terminal device side of a user and includes:

after being in range of a wireless local area network, sending a request for accessing the network to a wireless access device;

receiving an authentication page returned by the wireless access device, wherein the authentication page provides a speech decoding function;

detecting an audio signal played by a terminal device of an administrator, and decoding the audio signal using the speech decoding function provided by the authentication page to obtain authentication information;

loading the authentication information into the authentication page to return the authentication information to the wireless access device so that the wireless access device determines whether to permit the terminal device of the user to access the network according to the authentication information.

The present disclosure further provides a terminal device of an administrator, including:

one or more processors; and

a memory;

wherein one or more programs are stored in the memory, and when executed by the one or more processors, the one or more programs cause the one or more processors to perform:

obtaining an authentication instruction of permitting a terminal device of the user to access the network;

according to the authentication instruction, coding pre-stored authentication information by a pre-configured speech coding algorithm to obtain an audio signal;

playing the audio signal and sending the authentication information to a wireless access device, so that after the terminal device of the user detects the audio signal, the terminal device of the user decodes the audio signal to obtain the authentication information and then returns the authentication information to the wireless access device, and the wireless access device determines whether to permit the terminal device of the user to access the network according to the authentication information.

In an embodiment, the one or more processors are further configured to perform encrypting the authentication information;

wherein the one or more processors are configured to perform coding the encrypted authentication information by the pre-configured speech coding algorithm to obtain the audio signal;

wherein the one or more processors are configured to perform sending the encrypted authentication information to the wireless access device.

In an embodiment, the one or more processors are further configured to perform, after detecting that the terminal device of the user is in range of the wireless access network, popping up prompt information;

wherein the one or more processors are configured to perform obtaining the authentication instruction of permitting the terminal device of the user to access the network which is input by the administrator according to the prompt information.

In an embodiment, the one or more processors are configured to perform negotiation communication with the wireless access device to configure the speech coding algorithm and frequency setting information, wherein the frequency setting information comprises a sending frequency of the audio signal.

In an embodiment, the one or more processors are further configured to perform, according to a distance from the terminal device of the user, adjusting a sending volume of the audio signal.

The present disclosure further provides a terminal device of a user, including:

one or more processors; and

a memory;

wherein one or more programs are stored in the memory, and when executed by the one or more processors, the one or more programs cause the one or more processors to perform:

after being in range of a wireless local area network, sending a request for accessing the network to a wireless access device;

receiving an authentication page returned by the wireless access device, wherein the authentication page provides a speech decoding function;

detecting an audio signal played by a terminal device of an administrator, and decoding the audio signal using the speech decoding function provided by the authentication page to obtain authentication information;

loading the authentication information into the authentication page to return the authentication information to the wireless access device so that the wireless access device determines whether to permit the terminal device of the user to access the network according to the authentication information.

In an embodiment, the speech decoding function provided by the authentication page is implemented by a script carried in the authentication page.

In an embodiment, the one or more processors are configured to perform: receiving the authentication page which is returned by the wireless access device after the wireless access verifies that terminal device of the user is not a terminal device in a black list and/or a white list; and

receiving information indicating network access failure returned by the wireless access device after the wireless access device verifies that the terminal device of the user is a terminal device in the black list; and/or receiving information indicating that the terminal device of the user is permitted to access the network after the wireless access device verifies that the terminal device of the user is a terminal device in the white list.

In an embodiment, the authentication page carries frequency setting information which comprises a sending frequency of the audio signal;

wherein the one or more processors are configured to perform, according to the sending frequency of the audio signal, detecting the audio signal played by the terminal device of the administrator.

The present disclosure further provides a system for authenticating a user of a wireless local area network, including the above terminal device of an administrator, the terminal device of a user, and a wireless access device;

wherein the wireless access device is configured to receive authentication information sent by the terminal device of the administrator, receive authentication information returned by the terminal device of the user through loading the authentication information into an authentication page, compare the authentication information returned by the terminal device of the administrator and the authentication information returned by the terminal device of the user, and if the two authentication information is consistent with each other, permit the terminal device of the user to access the network

In the method and system for authenticating a user of a wireless local area network and the terminal device provided by the present disclosure, a terminal device of an administrator converts authentication information into an audio signal and plays the audio signal to a terminal device of a user; the terminal device of the user obtains the authentication information by decoding so that a wireless access device may determine whether to permit the terminal device of the user to access a network according to the authentication information. Such authentication approach requires neither manual input of authentication information by the user nor manual operation on the wireless access device by the administrator, and thereby convenience of authentication is greatly improved.

The above illustration is only a general description of the technical solutions provided by the present disclosure, aiming at making the technical means of the present disclosure understood more clearly and thereby practiced based on the contents of the specification. Further, in order to make the above and other objects, features and advantages of the present disclosure more obvious, specific implementations of the present disclosure will be exemplified below.

### BRIEF DESCRIPTION OF THE DRAWINGS

One of ordinary skill in this art will appreciate other advantages from the following detailed description of exemplary embodiments herein. Drawings are only for showing exemplary embodiments but not for limiting the scope of the present disclosure. Through the drawings, similar reference numbers represent similar elements.

FIG. 1 is a flowchart showing a method for authenticating a user of a wireless local area network according to a first embodiment of the present disclosure;

FIG. 2 is a flowchart showing a method for authenticating a user of a wireless local area network according to a second embodiment of the present disclosure;

FIG. 3 is a flowchart showing a method for authenticating a user of a wireless local area network according to a third embodiment of the present disclosure;

FIG. 4 is a functional block diagram showing a terminal device of an administrator according to another embodiment of the present disclosure;

FIG. 5 is a functional block diagram showing a terminal device of a user according to another embodiment of the present disclosure;

FIG. 6 is a functional block diagram showing a system for authenticating a user of a wireless local area network according to another embodiment of the present disclosure;

FIG. 7 is a structural block diagram for a terminal device of an administrator according to another embodiment of the present disclosure; and

FIG. 8 is a structural block diagram for a terminal device of a user according to another embodiment of the present disclosure.

### DESCRIPTION OF THE EMBODIMENTS

Exemplary embodiments of the present disclosure will be described below in detail with reference to drawings. Even though exemplary embodiments of the present disclosure are presented in drawings, it shall be appreciated that the present disclosure may be practiced in various manners without being limited to the embodiments set forth herein. Instead, the embodiments are provided herein to make the present disclosure be understood more thoroughly and to more completely convey the scope of the present disclosure to one of ordinary skill in this art.

In the present disclosure, with popularization of smart terminal devices at present, when a new user inquires an administrator about a password, the administrator only needs to play a sound via his/her smart terminal device to a device of the new user, and the new user may directly join a network after the smart terminal device of this new user receives the sound. The sound is a high-frequency or low-frequency audio signal converted according to a WiFi password, and after the device of the new user receives this audio signal, the audio signal may be converted back to the WiFi password by decoding.

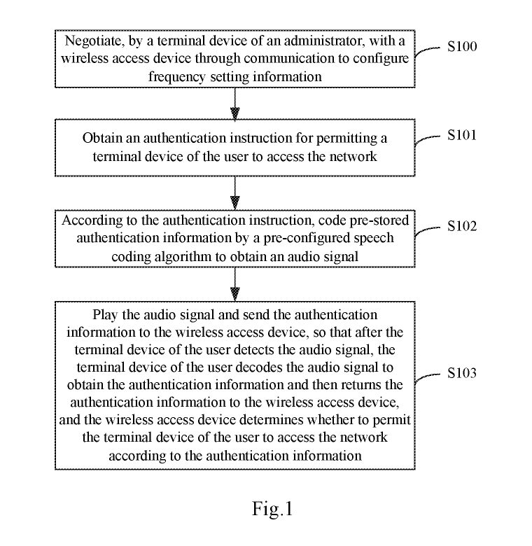

FIG. 1 is a flowchart showing a method for authenticating a user of a wireless local area network according to a first embodiment of the present disclosure. As shown in FIG. 1, the method is performed at a terminal device side of an administrator. The terminal device may be a mobile phone, and however, the present disclosure is not limited to this, other terminal devices capable of providing the same functions are also possible, for example, table computers or PDA and the like also belong to the category of the terminal device in the present disclosure. The method of the present embodiment specifically includes the following steps.

In step S101, an authentication instruction of permitting a terminal device of a user to access the network is obtained.

When a user A finds a WiFi network via a terminal device and the terminal device is connected to the network, if the user A wants to get online, an application program (for example, a browser) in the terminal device pops up an authentication page, and the user A needs to input a WiFi password on the authentication page to get online. At this time, the user A may directly inquire an administrator B, and if the administrator B permits the terminal device of the user A to access the network, the administrator B inputs an authentication instruction, and a terminal device of the administrator B accordingly obtains the authentication instruction of permitting the terminal device of the user A to access the network.

Optionally, in another scenario where after the terminal device of the user A is connected to the WiFi network and the terminal device of the administrator B detects that the user A is in range of the WiFi network, the terminal device of the administrator B pops up prompt information for reminding the administrator B that there is a new user joining the WiFi network, and the administrator B inputs an authentication instruction of permitting the terminal device of the user A to access the network according to the prompt information.

In step 102, according to the authentication instruction, pre-stored authentication information is coded by a pre-configured speech coding algorithm to obtain an audio signal.

After obtaining the authentication instruction, the terminal device of the administrator B converts pre-stored authentication information into a sound (i.e., an audio signal) by using a pre-configured speech coding algorithm. The authentication information may be a WiFi password for example, and the WiFi password may be pre-configured by the administrator and stored in the terminal device of the administrator.

Any one of conversion methods in prior arts may be used to convert the authentication information into a sound, and detailed descriptions thereof are omitted here.

The pre-configured speech coding algorithm is determined in advance by negotiation communication with the wireless access device, i.e., prior to the step S101, the terminal device of the administrator communicates with the wireless access device, downloads the speech coding algorithm from the wireless access device, and the terminal device of the administrator may perform sound conversion based on the speech coding algorithm later.

Optionally, before the coding conversion, the WiFi password may be encrypted by a preset encryption algorithm, such as a MD5 encryption algorithm by which the WiFi password may be converted into a MD5 string; then the encrypted string is converted into a sound (i.e., an audio signal) by the speech coding algorithm. By encrypting the WiFi password, the WiFi password is prevented from being stolen by other user terminal devices and thereby transmission security is improved.

The encryption algorithm for encrypting the WiFi password in the present disclosure is not limited to the MD5 algorithm but other encryption algorithms are also possible. The encryption algorithm here may also be determined in advance by negotiation communication with the wireless access device.

In step S103, the audio signal is played and the authentication information is sent to a wireless access device, so that after the terminal device of the user detects the audio signal, the terminal device of the user decodes the audio signal to obtain the authentication information and then returns the authentication information to the wireless access device, and the wireless access device determines whether to permit the terminal device of the user to access the network according to the authentication information.

The terminal device of the administrator B plays a sound via a speaker. A microphone of the terminal device of the user A monitors sounds around the terminal device, and after detecting a sound, the terminal device decodes the sound to obtain the authentication information. If the authentication information is encrypted, the decoded information is an encrypted string such as a MD5 string. The terminal device of the user A loads the authentication information into the authentication page to return the authentication information to the wireless access device.

In this step, the terminal device of the administrator B also sends the authentication information to the wireless access device concurrently to make the wireless access device perform authentication. If the authentication information is encrypted, the terminal device of the administrator B sends the encrypted authentication information, i.e., the encrypted string, to the wireless access device.

The wireless access device compares the authentication information returned by the terminal device of the administrator B and the authentication information returned by the terminal device of the user A; if the two authentication information is consistent with each other, the wireless access device permits the terminal device of the user A to access the network; if the two authentication information is not consistent with each other, the wireless access device denies the terminal device of the user A access to the network.

In order to facilitate receiving of the sound by the user terminal and to avoid noise interference, it is usually required to play sounds of a predetermined frequency such as a high frequency or a low frequency, for example, 1000 Hz or 200 Hz. The authentication information is coded into the sound wave, and when sounds are played, the microphone of the user terminal receives the sounds and a filter of the user device filters the sounds to find out the sound of the predetermined frequency, and decodes the sound wave to obtain the authentication information. By providing sound of the predetermined frequency, noise interference may be avoided. Specifically, before playing of the audio signal (optionally, before step S101), the method may further includes: in step S100, the terminal device of the administrator B negotiates with the wireless access device by communication to configure frequency setting information which includes a sending frequency of the audio signal. The terminal device of the user filters the received audio signals according to the predetermined sound frequency to filter out interference.

Because the distance between the terminal device of the user and the terminal device of the administrator is varied, before playing the sound, the terminal device of the administrator may firstly detects the distance between the terminal device of the user and the terminal device of the administrator and accordingly set the volume for playing the sound according to the distance between the two devices. If the distance exceeds a preset value, the volume for playing the sound may be increased; if the distance is below a certain distance, the strength for playing the sound may be lowered; thus, terminal devices of users at different distances may clearly receive the sound. Since wireless local area networks are often disposed in relatively noisy environments and are not allowed to produce a large sound as a terminal device, under such condition, an external sound playing device such as a speaker may be used to play sound, and the terminal device of the administrator may control the speaker to play corresponding sound. At this time, the administrator may be at a relatively farther distance from the user, and the user may receive the sound carrying the authentication information such as the WiFi password issued from the speaker without getting close to the administrator.

In the method for authenticating a user of a wireless local area network provided by the present embodiment, a terminal device of an administrator converts authentication information into an audio signal and plays the audio signal to a terminal device of a user; the terminal device of the user obtains the authentication information by decoding so that a wireless access device may determine whether to permit the terminal device of the user to access a network according to the authentication information. Such authentication approach requires neither manual input of authentication information by the user nor manual operation on the wireless access device by the administrator, and thereby convenience of authentication is greatly improved.

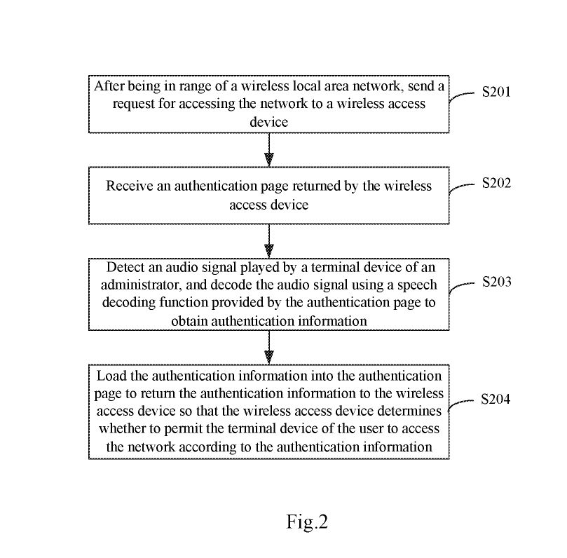

FIG. 2 is a flowchart showing a method for authenticating a user of a wireless local area network according to a second embodiment of the present disclosure. As shown in FIG. 2, the method is performed at a terminal device side of a user. The method specifically includes the following step.

In step S201, after being in range of a wireless local area network, a request for accessing the network is sent to a wireless access device.

When a user A finds a WiFi network via a terminal device, and the terminal device is connected to the network, if the user A wants to get online, the terminal device may send a request for accessing the network to a wireless access device. For example, the terminal device of the user A starts a browser, and the browser sends a request for access a page to the wireless access device.

In step S202, an authentication page returned by the wireless access device is received.

After receiving the request for access the network sent from the terminal device of the user A, the wireless access device returns an authentication page to the terminal device of the user A. The user A needs to input a WiFi password on the authentication page to get online.

In the present disclosure, the authentication page provides a speech decoding function, for example, the authentication page itself carries codes having a speech decoding function, or the speech decoding function provided by the authentication page is implemented by a script. The speech decoding function utilizes a speech decoding algorithm pre-configured in the wireless access device and the speech decoding algorithm corresponds to the previously mentioned speech coding algorithm. If the authentication page itself provides the speech decoding function, when the authentication page is fed back to the terminal device of the user, the authentication page itself may obtain the WiFi password by decoding via correct manners. Thus, for the terminal device of the user, decoding may be realized by the speech decoding function directly provided in the authentication page, and thus the access operation for the terminal device of the user becomes more convenient.

In step S203, an audio signal played by a terminal device of an administrator is detected, and the detected audio signal is decoded using the speech decoding function provided by the authentication page to obtain authentication information.

After step S202, the terminal device of the user pops up the authentication page on which a microphone of the terminal device of the user is open. According to the first embodiment of the present disclosure, the terminal device of the administrator B may play sounds via a speaker, and the microphone of the terminal device of the user A monitors the sounds around the terminal device, and after detecting a sound, the authentication page decodes the sound to obtain the authentication information. If the authentication information is encrypted, the decoded information is an encrypted string such as a MD5 string.

In the present disclosure, after the authentication page arrives at the user terminal device side, the page opens the microphone to monitor sounds, and after detects a sound, the page performs decoding to obtain the authentication information. All these functions are performed by the authentication page itself and no other auxiliary application program is needed, and thus the convenience for the access operation of the terminal device of the user is greatly improved.

In step S204, the authentication information is loaded into the authentication page to return the authentication information to the wireless access device so that the wireless access device determines whether to permit the terminal device of the user to access the network according to the authentication information.

The terminal device of the user A loaded the authentication information into the authentication page to return it to the wireless access device.

The wireless access device compares the authentication information returned by the terminal device of the administrator B and the authentication information returned by the terminal device of the user A; if the two authentication information is consistent with each other, the wireless access device permits the terminal device of the user A to access the network; if the two authentication information is not consistent with each other, the wireless access device denies the terminal device of the user A access to the network.

In the method, the authentication page may also carry frequency setting information which includes a sending frequency of the audio signal. The step S203 may be further defined as detecting the audio signal played by the terminal device of the administrator according to the sending frequency of the audio frequency.

Further, a black list and/or a white list of terminal devices may be stored in the wireless access device. The black list contains configuration information regarding terminal devices which are not permitted to access the network. The white list contains configuration information regarding terminal devices which are permitted to access the network. The black list and the white list may be configured by the administrator, or may be configured according to history recordings. For example, the white list records terminal devices which passed authentication in the past, and the black list records terminal devices which did not pass authentication in the past.

Before step S202, the wireless access device verifies whether the terminal device of the user is a terminal device in the black list and/or the white list. If not, the wireless access device returns the authentication page to the terminal device of the user; if the wireless access device verifies that the terminal device of the user is a terminal device in the black list, the wireless access device returns information indicating network access failure; and/or, if the wireless access device verifies that the terminal device of the user is a terminal device in the white list, the wireless access device permits the terminal device of the user to access the network. By providing the black list/white list in the wireless access device, the efficiency for user access operation is improved.

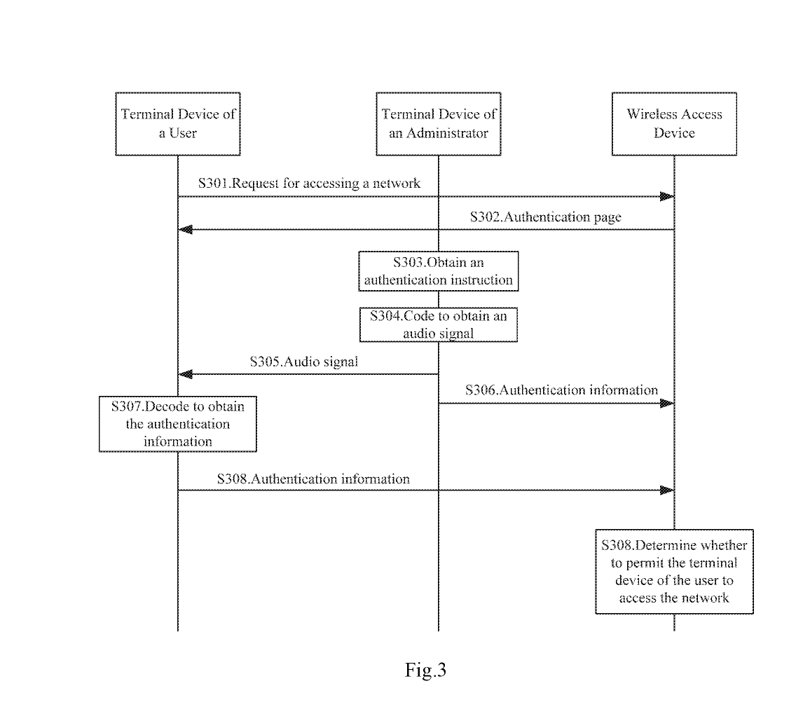

FIG. 3 is a flowchart showing a method for authenticating a user in a wireless local area network according to a third embodiment of the present disclosure. As shown in FIG. 3, the flowchart chart shows the interactions among a terminal device of an administrator, a terminal device of a user and a wireless access device. The method includes the following steps.

In step S301, after being in range of a wireless local area network, the terminal device of the user sends a request for access the network to the wireless access device.

In step S302, the terminal device of the user receives an authentication page returned by the wireless access device.

In step S303, the terminal device of the administrator obtains an authentication instruction of permitting the terminal device of the user to access the network.

In a scenario, after step S302, the user inquires the administrator, and the administrator inputs the authentication instruction of permitting the terminal device of the user to access the network.

In another scenario, after the terminal device of the user is connected to the WiFi network, the terminal device of the administrator detects that that the terminal device of the user is in range of the WiFi network, the terminal device of the administrator pops up prompt information for reminding the administrator that there is a new user joining the WiFi network, and the administrator inputs the authentication instruction of permitting the terminal device of the user to access the network according to the prompt information. In this scenario, step S303 may be performed before step S302.

In step S304, the terminal device of the administrator codes pre-stored authentication information by a pre-configured speech coding algorithm to obtain an audio signal.

In step S305, the terminal device of the administrator plays the audio signal.

In step S306, the terminal device of the administrator sends the authentication information to the wireless access device.

The above step S306 may be performed before step S305 or may be performed concurrently with step S305.

In step S307, the terminal device of the user detects the audio sound played by the terminal device of the administrator, and decodes the audio signal using a speech decoding function provided by the authentication page to obtain the authentication information.

In step S308, the terminal device of the user loads the authentication information into the authentication page to return it to the wireless access device.

In step S309, the wireless access device determines whether to permits the terminal device of the user to access the network according to the authentication information.

In the method for authenticating a user of a wireless local area network provided by the present embodiment, a terminal device of an administrator converts authentication information into an audio signal and plays the audio signal to a terminal device of a user; the terminal device of the user obtains the authentication information by decoding so that a wireless access device may determine whether to permit the terminal device of the user to access a network according to the authentication information. Such authentication approach requires neither manual input of authentication information by the user nor manual operation on the wireless access device by the administrator, and thereby convenience of authentication is greatly improved.

FIG. 4 is a functional block diagram showing a terminal device of an administrator according to another embodiment of the present disclosure. As shown in FIG. 4, the terminal device 40 of an administrator includes an obtaining module 41, a coding module 42, an audio playing module 43 and a first sending module 44.

The obtaining module 41 is configured to obtain an authentication instruction of permitting a terminal device of the user to access the network.

The coding module 42 is configured to, according to the authentication instruction, code pre-stored authentication information by a pre-configured speech coding algorithm to obtain an audio signal.

The audio playing module 43 is configured to play the audio signal.

The first sending module 44 is configured to send the authentication information to a wireless access device, so that after the terminal device of the user detects the audio signal, the terminal device of the user decodes the audio signal to obtain the authentication information and then returns the authentication information to the wireless access device, and the wireless access device determines whether to permit the terminal device of the user to access the network according to the authentication information.

Optionally, the terminal device of the administrator further includes an encrypting module 45 configured to encrypt the authentication information. The coding module 42 is specifically configured to code the encrypted authentication information by the pre-configured speech coding algorithm to obtain the audio signal. The first sending module 44 is specifically configured to send the encrypted authentication information to the wireless access device.

Optionally, the terminal device of an administrator further includes a detecting module 46 and a prompt module 47.

The detecting module 46 is configured to detect that the terminal device of the user is in range of the wireless access network.

The prompt module 47 is configured to pop up prompt information indicating that the terminal device of the user is in range of the wireless access network.

The obtaining module 41 is specifically configured to obtain the authentication instruction of permitting the terminal device of the user to access the network which is input by the administrator according to the prompt information.

Optionally, the terminal device of an administrator further includes a configuration module 48 configured to perform negotiation communication with the wireless access device to configure the speech coding algorithm and frequency setting information, wherein the frequency setting information comprises a sending frequency of the audio signal.

Considering that the distance between the terminal device of a user and the terminal device of an administrator is varied, the audio playing module 43 is further configured to, according to a distance from the terminal device of the user, adjust a sending volume of the audio signal.

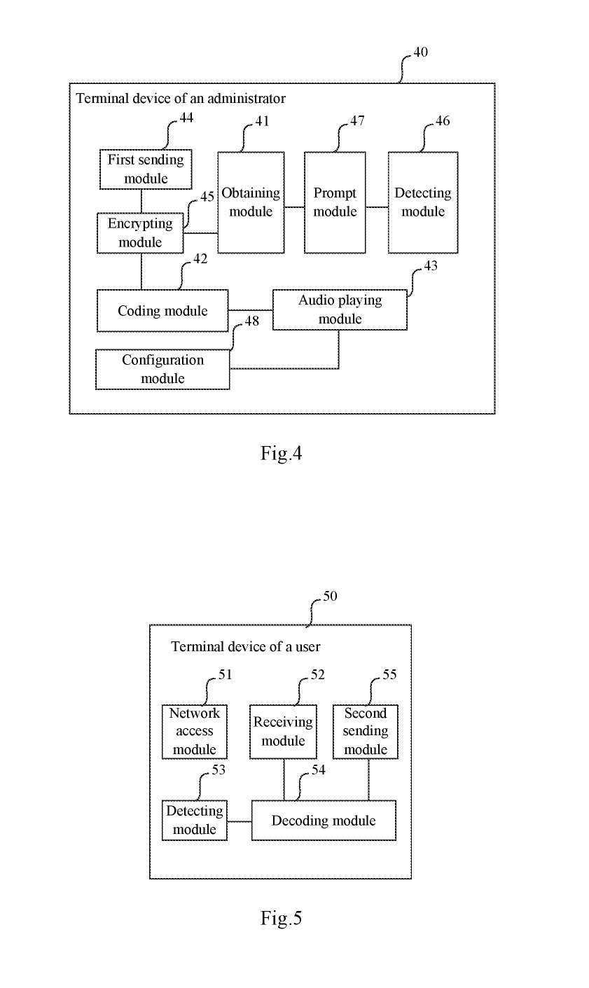

FIG. 5 is a functional block diagram showing a terminal device of a user according to another embodiment of the present disclosure. As shown in FIG. 5, the terminal device 50 of a user includes a network access module 51, a receiving module 52, a detecting module 53, a decoding module 54 and a second sending module 55.

The network access module 51 is configured to, after being in range of a wireless local area network, send a request for accessing the network to a wireless access device.

The receiving module 52 is configured to receive an authentication page returned by the wireless access device, wherein the authentication page provides a speech decoding function.

The detecting module 53 is configured to detect an audio signal played by a terminal device of an administrator.

The decoding module 54 is configured to decode the audio signal using the speech decoding function provided by the authentication page to obtain authentication information.

The second sending module 55 is configured to load the authentication information into the authentication page to return the authentication information to the wireless access device so that the wireless access device determines whether to permit the terminal device of the user to access the network according to the authentication information.

Optionally, the function of the decoding module 54 is implemented by a script carried in the authentication page.

The receiving module 52 is further configured to:

receive the authentication page which is returned by the wireless access device after the wireless access verifies that terminal device of the user is not a terminal device in a black list and/or a white list; and

receive information indicating network access failure returned by the wireless access device after the wireless access device verifies that the terminal device of the user is a terminal device in the black list; and/or receive information indicating that the terminal device of the user is permitted to access the network after the wireless access device verifies that the terminal device of the user is a terminal device in the white list.

Optionally, authentication page carries frequency setting information which comprises a sending frequency of the audio signal. The detecting module 53 is further configured to, according to the sending frequency of the audio signal, detect the audio signal played by the terminal device of the administrator.

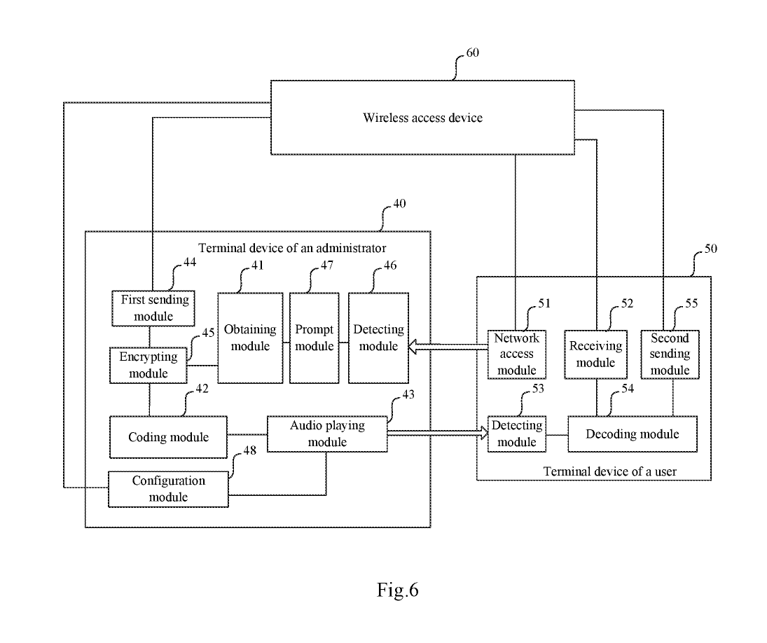

FIG. 6 is a functional block diagram showing a system for authenticating a user of a wireless local area network according to another embodiment of the present disclosure. As shown in FIG. 6, the system includes a terminal device 40 of an administrator, a terminal device 50 of a user and a wireless access device 60. For the specific functions of the terminal device 40 of an administrator and the terminal device 50 of a user, the description of the above embodiments may be referred to. The wireless access device 60 is configured to receive authentication information sent by the terminal device 40 of the administrator, receive authentication information returned by the terminal device 50 of the user through loading the authentication information into an authentication page, compare the authentication information returned by the terminal device 40 of the administrator and the authentication information returned by the terminal device 50 of the user, and if the two authentication information is consistent with each other, permit the terminal device of the user to access the network.

In the system for authenticating a user of a wireless local area network provided by the present embodiment, a terminal device of an administrator converts authentication information into an audio signal and plays the audio signal to a terminal device of a user; the terminal device of the user obtains the authentication information by decoding so that a wireless access device may determine whether to permit the terminal device of the user to access a network according to the authentication information. Such authentication approach requires neither manual input of authentication information by the user nor manual operation on the wireless access device by the administrator, and thereby convenience of authentication is greatly improved.

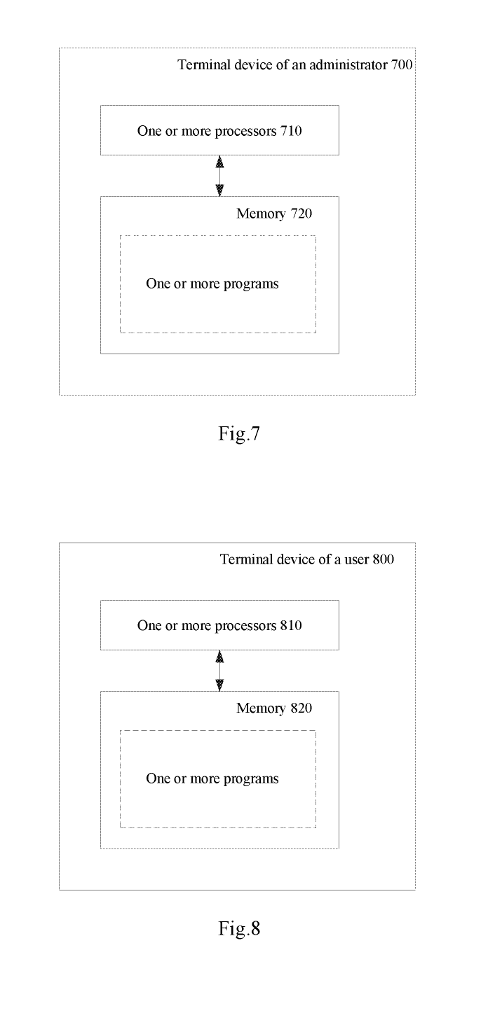

FIG. 7 is a structural block diagram for a terminal device of an administrator according to another embodiment of the present disclosure. The terminal device of the administrator 700 includes: one or more processors 710; and a memory 720; one or more programs, wherein one or more programs are stored in the memory, and when executed by the one or more processors, the one or more programs cause the one or more processors to perform the method performed at a terminal device side of an administrator provided in the present disclosure.

FIG. 8 is a structural block diagram for a terminal device of a user according to another embodiment of the present disclosure. The terminal device of the user 800 includes: one or more processors 810; and a memory 820; one or more programs, wherein one or more programs are stored in the memory, and when executed by the one or more processors, the one or more programs cause the one or more processors to perform the method performed at a terminal device side of an user provided in the present disclosure.

The above description has presented and illustrated many exemplary embodiments of the present disclosure, and however, as stated above, it shall be appreciated that the present disclosure is not limited to the implementations disclosed herein, providing these exemplary embodiments shall not be deemed as excluding other embodiments. Instead, the technical solutions in the present disclosure may be applied in any other combinations, variations and environments, and may be modified based on the above teaching or technologies or knowledge in related fields within the conceiving scope of the present disclosure. Any modifications or changes performed by one of ordinary skill in this art without departing from the spirit and scope of the present disclosure shall fall within the protection scope as defined by appended claims.

What is claimed is:

1. A method for authenticating a user of a wireless local area network, wherein the method is executed at a terminal device side of an administrator and comprises:
obtaining an authentication instruction of permitting a terminal device of the user to access the network;
according to the authentication instruction, coding pre-stored authentication information by a pre-configured speech coding algorithm to obtain an audio signal; and
playing the audio signal and sending the authentication information to a wireless access device, so that after the terminal device of the user detects the audio signal, the terminal device of the user decodes the audio signal to obtain the authentication information and then returns the authentication information to the wireless access device, and the wireless access device determines whether to permit the terminal device of the user to access the network according to the authentication information.

2. The method according to claim 1, wherein before coding the pre-stored authentication information by the pre-configured speech coding algorithm to obtain the audio signal, the method further comprises encrypting the authentication information;
wherein coding the pre-stored authentication information by the pre-configured speech coding algorithm to obtain the audio signal comprises: coding the encrypted authentication information by the pre-configured speech coding algorithm to obtain the audio signal; and
wherein sending the authentication information to the wireless access device comprises: sending the encrypted authentication information to the wireless access device.

3. The method according to claim 1, wherein before obtaining the authentication instruction of permitting the terminal device of the user to access the network, the method further comprises:
after detecting that the terminal device of the user is in range of the wireless access network, popping up prompt information;
wherein the obtaining the authentication instruction of permitting the terminal device of the user to access the network comprises: obtaining the authentication instruction of permitting the terminal device of the user to access the network which is input by the administrator according to the prompt information.

4. The method according to claim 1, wherein before obtaining the authentication instruction of permitting the terminal device of the user to access the network, the method further comprises: performing a negotiation communication with the wireless access device to configure the speech coding algorithm and frequency setting information, wherein the frequency setting information comprises a sending frequency of the audio signal.

5. The method according to claim 1, further comprising: according to a distance from the terminal device of the user, adjusting a sending volume of the audio signal.

6. A method for authenticating a user of a wireless local area network, wherein the method is performed at a terminal device side of a user and comprises:
after being in range of a wireless local area network, sending a request for accessing the network to a wireless access device;
receiving an authentication page returned by the wireless access device, wherein the authentication page provides a speech decoding function;
detecting an audio signal played by a terminal device of an administrator, and decoding the audio signal using the speech decoding function provided by the authentication page to obtain authentication information; and
loading the authentication information into the authentication page to return the authentication information to the wireless access device so that the wireless access device determines whether to permit the terminal device of the user to access the network according to the authentication information.

7. The method according to claim 6, wherein the speech decoding function provided by the authentication page is implemented by a script carried in the authentication page.

8. The method according to claim 6, where before receiving the authentication page returned by the wireless access device, the method further comprises: the wireless access device verifying whether the terminal device of the user is a terminal device in a black list and/or a white list; if the terminal device of the user is not a terminal device in the black list and/or the white list, the wireless access device returning the authentication page to the terminal device of the user;
wherein the method further comprises: if the wireless access device verifies that the terminal device of the user is a terminal device in the black list, the wireless access device returning information indicating network access failure; and/or, if the wireless access device verifies that the terminal device of the user is a terminal device in the white list, the wireless access device permitting the terminal device of the user to access the network.

9. The method according to claim 6, wherein the authentication page carries frequency setting information which comprises a sending frequency of the audio signal;
wherein detecting the audio signal played by the terminal device of the administrator, comprises: according to the sending frequency of the audio signal, detecting the audio signal played by the terminal device of the administrator.

10. A terminal device of an administrator, comprising:
one or more processors; and
a memory;
wherein one or more programs are stored in the memory, and when executed by the one or more processors, the one or more programs cause the one or more processors to perform:
obtaining an authentication instruction of permitting a terminal device of the user to access the network;
according to the authentication instruction, coding pre-stored authentication information by a pre-configured speech coding algorithm to obtain an audio signal;
playing the audio signal and sending the authentication information to a wireless access device, so that after the terminal device of the user detects the audio signal, the terminal device of the user decodes the audio signal to obtain the authentication information and then returns the authentication information to the wireless access device, and the wireless access device determines whether to permit the terminal device of the user to access the network according to the authentication information.

11. The terminal device of an administrator according to claim 10, wherein the one or more processors are further configured to perform encrypting the authentication information;
wherein the one or more processors are configured to perform coding the encrypted authentication information by the pre-configured speech coding algorithm to obtain the audio signal;
wherein the one or more processors are configured to perform sending the encrypted authentication information to the wireless access device.

12. The terminal device of an administrator according to claim 10, wherein the one or more processors are further configured to perform, after detecting that the terminal device of the user is in range of the wireless access network, popping up prompt information;
wherein the one or more processors are configured to perform obtaining the authentication instruction of permitting the terminal device of the user to access the network which is input by the administrator according to the prompt information.

13. The terminal device of an administrator according to claim 10, wherein the one or more processors are configured to perform negotiation communication with the wireless access device to configure the speech coding algorithm and frequency setting information, wherein the frequency setting information comprises a sending frequency of the audio signal.

14. The terminal device of an administrator according to claim 10, wherein the one or more processors are further configured to perform, according to a distance from the terminal device of the user, adjusting a sending volume of the audio signal.

15. A terminal device of a user, comprising:
one or more processors; and
a memory;
wherein one or more programs are stored in the memory, and when executed by the one or more processors, the one or more programs cause the one or more processors to perform:
after being in range of a wireless local area network, sending a request for accessing the network to a wireless access device;
receiving an authentication page returned by the wireless access device, wherein the authentication page provides a speech decoding function;
detecting an audio signal played by a terminal device of an administrator, and decoding the audio signal using the speech decoding function provided by the authentication page to obtain authentication information;
loading the authentication information into the authentication page to return the authentication information to the wireless access device so that the wireless access device determines whether to permit the terminal device of the user to access the network according to the authentication information.

16. The terminal device of a user according to claim 15, wherein the speech decoding function provided by the authentication page is implemented by a script carried in the authentication page.

17. The terminal device of a user according to claim 15, wherein the one or more processors are configured to perform: receiving the authentication page which is returned by the wireless access device after the wireless access verifies that terminal device of the user is not a terminal device in a black list and/or a white list; and
receiving information indicating network access failure returned by the wireless access device after the wireless access device verifies that the terminal device of the user is a terminal device in the black list; and/or receiving information indicating that the terminal device of the user is permitted to access the network after the wireless access device verifies that the terminal device of the user is a terminal device in the white list.

18. The terminal device of a user according to claim 15, wherein the authentication page carries frequency setting information which comprises a sending frequency of the audio signal;
wherein the one or more processors are configured to perform, according to the sending frequency of the audio signal, detecting the audio signal played by the terminal device of the administrator.

19. A system for authenticating a user of a wireless local area network, comprising a terminal device of an administrator, a terminal device of a user and a wireless access device;
wherein the terminal device of an administrator comprises:
one or more processors; and
a memory;
wherein one or more programs are stored in the memory, and when executed by the one or more processors, the one or more programs cause the one or more processors to perform:
obtaining an authentication instruction of permitting a terminal device of the user to access the network;
according to the authentication instruction, coding pre-stored authentication information by a pre-configured speech coding algorithm to obtain an audio signal; and
playing the audio signal and sending the authentication information to a wireless access device, so that after the terminal device of the user detects the audio signal, the terminal device of the user decodes the audio signal to obtain the authentication information and then returns the authentication information to the wireless access device, and the wireless access device determines whether to permit the terminal device of the user to access the network according to the authentication information;
wherein the terminal device of a user comprises:
one or more processors; and
a memory;
wherein one or more programs are stored in the memory, and when executed by the one or more processors, the one or more programs cause the one or more processors to perform:
after being in range of a wireless local area network, sending a request for accessing the network to a wireless access device;
receiving an authentication page returned by the wireless access device, wherein the authentication page provides a speech decoding function;
detecting an audio signal played by a terminal device of an administrator, and decoding the audio signal using the speech decoding function provided by the authentication page to obtain authentication information; and
loading the authentication information into the authentication page to return the authentication information to the wireless access device so that the wireless access device determines whether to permit the terminal device of the user to access the network according to the authentication information;
wherein the wireless access device is configured to receive authentication information sent by the terminal device of the administrator, receive authentication information returned by the terminal device of the user through loading the authentication information into an authentication page, compare the authentication information returned by the terminal device of the administrator and the authentication information returned by the terminal device of the user, and if the two authentication information is consistent with each other, permit the terminal device to access the network.
